(19) United States
(12) Patent Application Publication
(10) Pub. No.: US 2019/0101078 A1
(43) Pub. Date: Apr. 4, 2019

(54) CYLINDER, METHOD FOR FINISHING A CYLINDER, RECIPROCATING PISTON SYSTEM AND USE OF A RECIPROCATING PISTON SYSTEM

(71) Applicants: Volkswagen AG, Wolfsburg (DE); Fraunhofer-Gesellschaft zur Foerderung der angewandten Forschung e.V., Muenchen (DE)

(72) Inventors: Marcel BORTFELDT, Eilsleben (DE); Ulf HARBS, Braunschweig (DE); Nils LEHRMANN, Braunschweig (DE); Andreas SCHUBERT, Dresden (DE); Daniel RICHTER, Gornau (DE); Torsten SCHMIDT, Freital (DE); Joerg SCHNEIDER, Chemnitz (DE)

(73) Assignees: Volkswagen AG, Wolfsburg (DE); Fraunhofer-Gesellschaft zur Foerderung der angewandten Forschung e.V., Muenchen (DE)

(21) Appl. No.: 16/205,361

(22) Filed: Nov. 30, 2018

Related U.S. Application Data
(63) Continuation of application No. PCT/EP2017/063163, filed on May 31, 2017.

(30) Foreign Application Priority Data
May 31, 2016 (DE) 102016110007.2

(51) Int. Cl. F02F 1/20; F16J 10/04; B21K 3/02; C23C 4/08; C23C 4/10

(52) U.S. Cl. CPC F02F 1/20; F16J 10/04; C23C 4/10; C23C 4/08; B21K 3/02

(57) ABSTRACT

A cylinder for a reciprocating piston system, with a cylinder running surface, which is finished by machining by means of a tool with a geometrically defined cutting edge, wherein the finished cylinder running surface has a multiplicity of pores and/or cavities and is formed from a grey cast iron material with a proportion of the surface area that is taken up by pores of 2 to 10% or is formed from a thermally sprayed layer of iron or a thermally sprayed layer of ceramic with a proportion of the surface area that is taken up by pores of 5 to 25%. A method is also provided for finishing a cylinder in which a cylinder running surface of the cylinder is finished by machining by a tool with a geometrically defined cutting edge such that after the finishing the cylinder surface has a multiplicity of pores and/or cavities.

This nonprovisional application is a continuation of International Application No. PCT/EP2017/063163, which was filed on May 31, 2017, and which claims priority to German Patent Application No. 10 2016 110 007.2, which was filed in Germany on May 31, 2016, and which are both herein incorporated by reference.

### BACKGROUND OF THE INVENTION

### Field of the Invention

The present invention relates to a cylinder for a reciprocating piston system. Furthermore, the invention relates to a method for finishing a cylinder for a reciprocating piston system. Furthermore, the invention relates to a reciprocating piston system and a use of a reciprocating piston system.

### Description of the Background Art

Cylinder running surfaces of cylinders of a reciprocating system are usually finished by honing. A honing process is described for example in EP 1 321 229 A1, which corresponds to US 2003/0120374.

The honing process is carried out in different method versions, depending on the material used. For light metal alloys (aluminum-silicon alloys), for example, stripping honing or fluid stripping honing is used to reset the aluminum matrix by a few microns, so that a piston ring slidingly contacting the cylinder running surface of the cylinder can slide on the silicon particles of the light alloy. In grey cast iron materials, a spiral gliding honing or plateau honing is applied. The structure introduced during honing in the form of micro-channels into the surface by means of a tool with a geometrically undefined cutting edge serves for example the supply of lubricants between the cylinder wall and the piston ring during operation. Investigations have shown that, due to wear, this honing structure is no longer present in the cylinder running surface after a certain period of operation, which can lead to an impairment in the operation of the reciprocating piston system, since then virtually no oil retention volume is present on the cylinder running surface. The surface quality and also the tribological properties of the cylinder running surface are thus greatly reduced. In addition, a honing process requires complex process technology and systems engineering, and the honing process is time-consuming and requires a large amount of cooling lubricant.

### SUMMARY OF THE INVENTION

It is therefore an object of the present invention to provide a cylinder, a method for finishing a cylinder as well as a reciprocating piston system and a use of a reciprocating piston system, in which an improved surface quality of a cylinder running surface of the cylinder can be achieved with simultaneously simplifying the process of finishing the cylinder running surface.

The cylinder for a reciprocating piston system according to the invention has a cylinder running surface, which is finished by machining, in particular boring, by means of a tool with one or several geometrically defined cutting edges, wherein the finished cylinder running surface has a plurality of pores and/or cavities and is formed from a grey cast iron material with a proportion of the surface area that is taken up by pores of 2 to 10%, or from a thermally sprayed iron layer or a thermally sprayed ceramic layer with a proportion of the surface area that is taken up by pores of 5 to 25%.

According to the method for finishing a cylinder for a reciprocating system according to the invention, a cylinder running surface of the cylinder is finished by machining, in particular boring, by means of a tool with a geometrically defined cutting edge in such a way that, after the finishing, the cylinder running surface has a plurality of pores and/or cavities, wherein the finished cylinder running surface is formed from a grey cast iron material with a proportion of the surface area that is taken up by pores of 2 to 10% or from a thermally sprayed iron layer or a thermally sprayed ceramic layer with a proportion of the surface area that is taken up by pores of 5 to 25%.

According to an exemplary embodiment of the invention, it is now provided that the cylinder running surface is no longer finished by a honing process, but that the finishing of the cylinder running surface is now carried out by a machining process, in particular a boring process, which is executed by means of a tool with a geometrically defined cutting edge. The cylinder running surface finished by machining, in particular boring, no longer has a cross-scoring structure, as would be the case with a finishing by honing, but a surface with a plurality of pores and/or cavities. Investigations have shown that a cylinder running surface having a large number of pores and/or cavities has substantially better tribological properties and thus also a higher surface quality than a cylinder running surface with a cross-scoring structure. For example, the pores and/or cavities generated by the machining can serve as oil pockets and thus create an oil retention volume, on which the piston ring can, so to speak, “float up” during the movement. A particularly advantageous oil retention volume can be achieved with a finished cylinder running surface made from a grey cast iron material with a proportion of the surface area that is taken up by pores of 2 to 10% or with a finished cylinder running surface of a thermally sprayed iron layer or a thermally sprayed ceramic layer with a proportion of the surface area that is taken up by pores of 5 to 25%. The proportion of the surface area that is taken up by pores indicates the proportion of the surface area of the pores per cylinder running surface. By finishing the cylinder running surface by means of machining with a defined cutting edge, in particular boring, the process of finishing can also be simplified. On the one hand, the structure of the process technology and systems engineering is less complex and, on the other hand, the method is simpler and can be carried out with shorter process times. By means of the tool with a geometrically defined cutting edge, two production steps, namely a machining surface treatment (separating) as well as a slight smoothing treatment (forming) are implemented, which lead to a very high surface quality of low roughness of the surface of the cylinder running surface. In connection with the chip formation, the steps of separating and forming can be influenced by a systematic design and position of the one or several cutting edge(s) of the tool. Preferably, one or several cutting edge(s) are used, which have a cutting edge radius of less than 10 μm and also have a sharp cutting edge, in order to be able to achieve a particularly correct separating cut between the cylinder running surface and the chip. A sharp cutting edge is characterized in that, given a correct separating cut, this results in low passive forces and, as a result, a low forming work on the cutting edge. This leads to a good, low base roughness and can lead to the tearing out of particles in inhomogeneous materials with hard, brittle phases. In contrast, a rounded cutting edge leads to higher passive forces and a higher forming work, due to which the cylinder running surface would be partially smoothed, particles would be embedded into the surface and shingling (sheet jacket formation) due to turned over roughness peaks can occur. In the worst case, pores are smeared with material, and thus the lubricant absorption capacity of the cylinder running surface is reduced. The step of smoothing is influenced by the targeted adjustment of a small setting angle of a secondary cutting edge on the tool, which enables a reduction of the kinematic roughness and the smoothing of remaining roughness peaks by repeatedly traversing with the cutting edge.

It is provided that the finished cylinder running surface formed from a grey cast iron material can have a proportion of the volume that is taken up by pores of 4 to 25 ml/m². The proportion of the volume that is taken up by pores is defined as the amount of oil that the pores can absorb on a given area. By a proportion of the volume that is taken up by pores of 4 to 25 ml/m², a particularly good oil retention volume can be achieved on the cylinder running surface formed from a grey cast iron material, whereby a friction occurring on the cylinder running surface can be reduced, and thus the wear of the cylinder running surface can be reduced.

If the finished cylinder running surface is formed from a thermally sprayed iron layer or from a thermally sprayed ceramic layer, it can be provided that the finished cylinder running surface has a proportion of the volume that is taken up by pores of 20 to 60 ml/m². By a proportion of the volume that is taken up by pores of 20 to 60 ml/m², a particularly good oil retention volume can be achieved at the cylinder running surface formed from a thermally sprayed iron layer or a thermally sprayed ceramic layer, whereby a friction occurring on the cylinder running surface can be reduced, and thus the wear of the cylinder running surface can be reduced.

The finished cylinder running surface can have a particularly smooth surface with many pores and/or cavities on the surface. For example, it is therefore provided that the finished cylinder running surface can have a roughness with a core roughness depth Rₖ<1.0 μm with a reduced peak height Rₚₖ<0.5 μm and a reduced groove depth Rᵥₖ of 0.5 to 8 μm. Particularly preferably, the finished cylinder running surface has a roughness with a core roughness depth Rk <0.6 μm. The core roughness depth Rₖ indicates the depth of the roughness core profile. The finished cylinder running surface further preferably has a reduced peak height Rₚₖ<0.5 μm, particularly preferably Rₚₖ<0.3 μm, with respect to the roughness. Furthermore, the finished running surface layer further preferably has a reduced groove depth Rᵥₖ of 0.5 μm to 8 μm with respect to the roughness.

If the cylinder running surface is formed from a grey cast iron material, the cylinder running surface formed from a grey cast iron material can be finished in such a way that hard material particles contained in the grey cast iron material are torn out. During casting, hard material phases, a so-called steadite net or phosphite eutectic, form in the grey cast iron material, which are distributed evenly in the grey cast iron material. In addition, so-called titanium carbides and titanium nitrides are formed in the grey cast iron material by the addition of the alloying element titanium. During the finishing by machining, in particular boring, of the grey cast iron material, the near-surface hard material particles, the titanium carbides and titanium nitrides, are torn out and thereby form part of the pores and/or cavities on the surface of the cylinder running surface. The remaining part of the pores and/or cavities on the surface of the cylinder running surface is formed by the brittle steadite net or phosphite eutectic. In the machining, in particular the boring, parts of the steadite net or phosphite eutectic are quarried when they are located on a graphite lamella. The graphite lamellae then form a kind of predetermined breaking point. As a result, particularly good tribological properties and thus a high surface quality can be achieved with a cylinder running surface formed from a grey cast iron material.

If the cylinder running surface is formed from a thermally sprayed iron layer or a thermally sprayed ceramic layer, the cylinder running surface formed from a thermally sprayed iron layer or a thermally sprayed ceramic layer can be finished in such a way that the pores and/or cavities formed in the cylinder running surface are exposed. During thermal spraying, a powder or a wire is melted, applied to the surface of the cylinder and solidifies on this surface, whereby the cylinder running surface is formed. As in this process the molten material is applied to the surface of the cylinder in the form of many individual drops to form the cylinder running surface, gases can be trapped between these drops. As a result, pores form between the coats of the layers. During the machining, in particular the boring, the near-surface pores can be opened and form recesses, which allow an improved oil retention volume. As a result, particularly good tribological properties and thus a high surface quality can be achieved with a cylinder running surface formed from a thermally sprayed iron layer or a thermally sprayed ceramic layer.

The method according to the invention is further preferably characterized in that the finishing can be carried out without a cooling lubricant. The method can therefore be carried out particularly environmentally friendly, since an otherwise required cooling lubricant preparation and disposal of the cooling lubricant can be omitted. Furthermore, this eliminates harmful oil vapors and skin-irritating media, so that a clean working environment can be created. Instead of a cooling lubricant, for example, an air-emulsion mixture or an air-oil mixture can be used for cooling. In order to achieve a particularly good and clean machining of the cylinder running surface, the cutting edge of the tool preferably has a cutting edge radius <10 μm. By a cutting edge radius <10 μm it can be prevented that the cutting edge slips over the surface of the cylinder running surface and thereby compresses the cylinder running surface, rather than to chip it.

In order to implement a cost-effective preventive non-circular machining to compensate for assembly and operational distortions in the finishing, it is preferably provided that the tool is used together with an adaptronic, radially deflectable spindle for a form processing for compensation of distortion. In this way, a particularly defined surface of the cylinder running surface can be generated with very accurate contours. The adaptronic spindle can enable a highly dynamic deflection by piezo actuators of up to 120 μm radially. In combination with the machining by the geometrically defined cutting edge of the tool, a three-dimensional form processing can be made possible.

The object of the invention is further achieved by means of a reciprocating piston system which has a cylinder and a piston movably mounted in the cylinder (possibly with an integrated piston ring), wherein the cylinder is configured and developed as described above.

According to the invention, the reciprocating piston system configured and developed as described above can be used in, for example, an internal combustion engine, a supercharger, a compressor or a pump. The use of the reciprocating piston system according to the invention is also conceivable in other facilities, devices, etc.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic view of a reciprocating piston system with a cylinder and a piston movably mounted in the cylinder, wherein a finishing of a cylinder running surface of the cylinder according to the invention is schematically shown,

FIG. 2 shows a view of a cylinder running surface machined in a honing process based on an SEM image,

FIG. 3 shows a view of a cylinder running surface according to the invention, machined by machining, in particular boring, based on an SEM image,

FIG. 4 shows a schematic view of a compressor with a reciprocating piston system according to the invention, and

FIG. 5 shows a schematic view of an internal combustion engine with a reciprocating piston system according to the invention.

### DETAILED DESCRIPTION

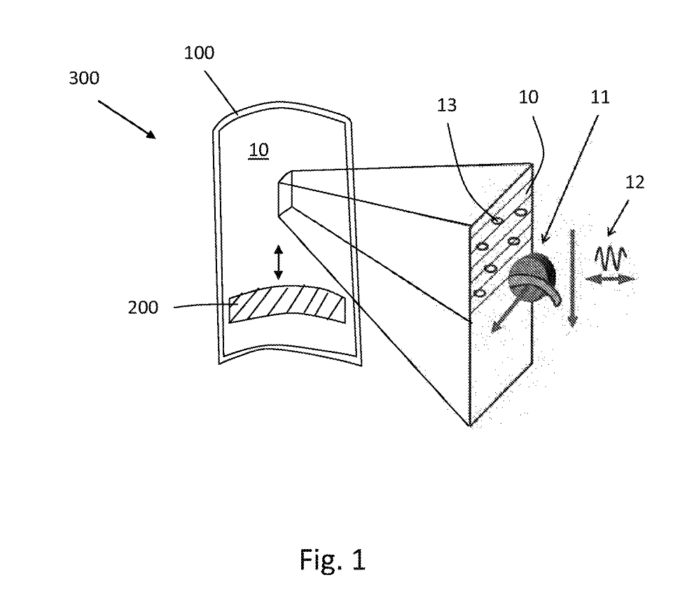

FIG. 1 shows a reciprocating piston system 300 with a cylinder 100 and a piston 200 movably mounted in the cylinder 100. The direction of movement of the piston 200 within the cylinder 100 is indicated by the arrows. The piston 200 can be driven, for example, by means of a connecting rod.

The cylinder 100 has a cylinder running surface 10 formed on its inner circumferential surface. The cylinder running surface 10 may be formed from a grey cast iron material or a thermally sprayed iron layer or a thermally sprayed ceramic layer.

In order to achieve a high surface quality with good tribological properties, a finishing of the cylinder running surface 10 occurs by machining with a defined cutting edge, in particular boring. The machining occurs by means of a tool with a geometrically defined cutting edge 11, through which a multiplicity of pores 13 and/or cavities are introduced into the cylinder running surface 10, which can produce a micro-pressure chamber system, by which, for example, the oil consumption of the reciprocating piston system 300 can be reduced.

The machining can replace the commonly used honing process for finishing a cylinder running surface 10. A honing process, which usually includes pre-honing, intermediate honing, fluid blasting and finish honing, can thereby be completely omitted.

In addition to the tool with a geometrically defined cutting edge 11 for performing the machining, in particular the boring, an adaptronic spindle 12 can be used, by which, in combination with the cutting edge 11, an optimized form processing for distortion compensation can be made possible, by which in turn honing deck plates can be omitted.

The machining in combination with the adaptronic spindle allows a three-dimensional form processing as a finishing of the cylinder running surface 10 for optimized distortion compensation.

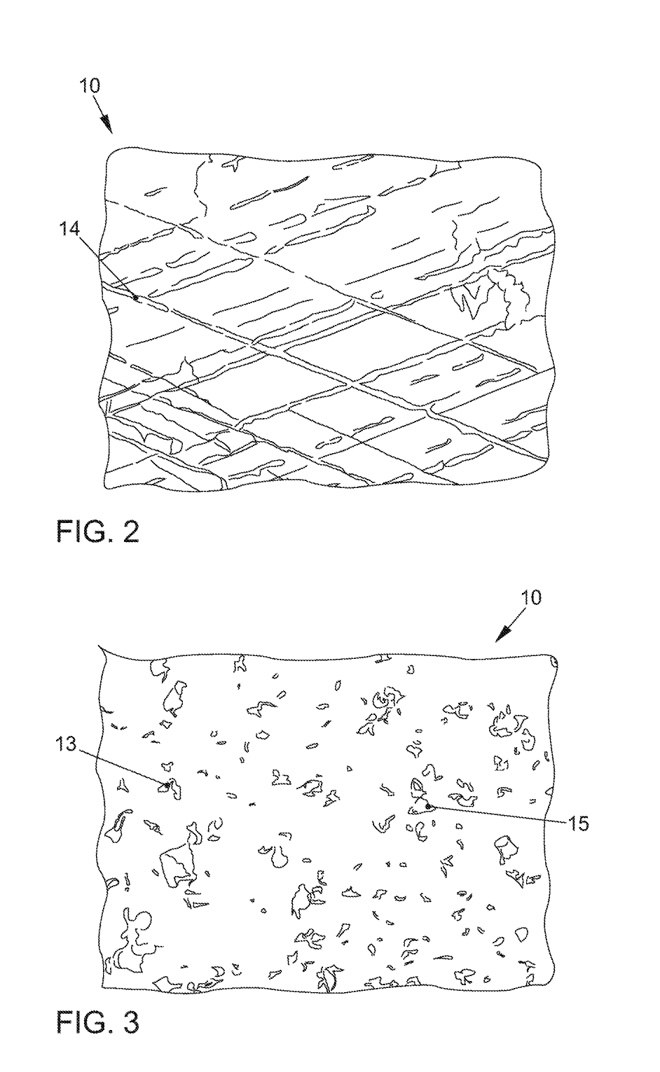

In order to illustrate the differences between a cylinder running surface 10 finished by a honing process and a cylinder running surface 10 finished by a machining according to the invention, in particular boring, FIG. 2 shows an SEM image of a cylinder running surface 10 finished in a honing process, and FIG. 3 shows an SEM image of a cylinder running surface 10 finished by means of a machining, in particular a boring.

The cylinder running surface 10 shown in FIG. 2 and configured in a honing process has a cross-scoring structure 14, wherein little or no pores and/or cavities are formed in the surface of the cylinder running surface 10.

FIG. 3, however, shows a cylinder running surface 10, which is finished according to the invention by machining, in particular boring, with a tool with a geometrically defined cutting edge 11. This cylinder running surface 10 has no cross-scoring structure. Instead, a plurality of pores 13 and/or cavities 15 are formed on the cylinder running surface 10, which allow a high oil retention volume, as these pores 13 and/or cavities 15 form trough-shaped recesses in which the oil of the reciprocating piston system 300 can accumulate and thus can be held at the cylinder running surface 10.

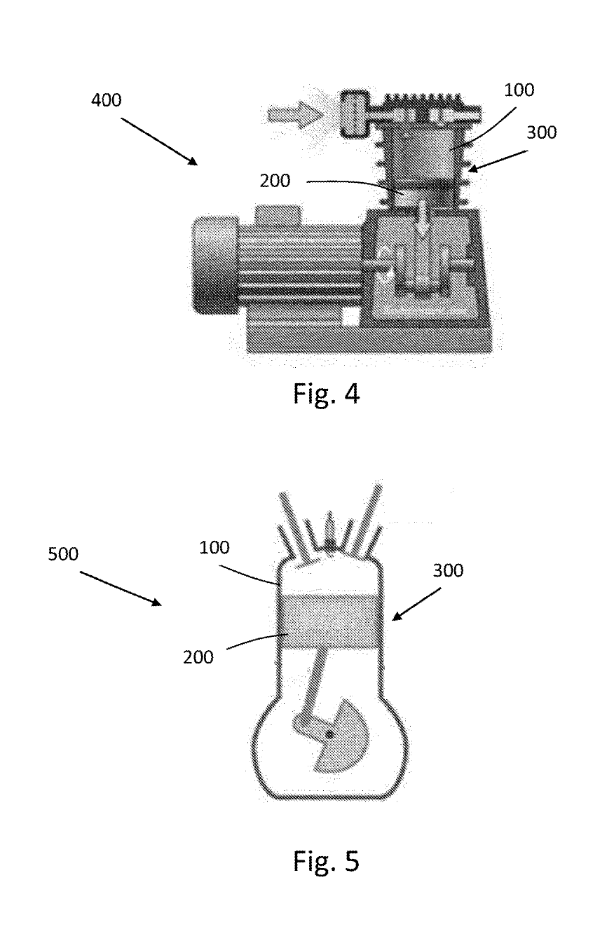

FIGS. 4 and 5 show two examples of a use of a reciprocating piston system 300 according to FIG. 1. Here, FIG. 4 shows a compressor 400 with a reciprocating piston system 300 as shown in FIG. 1. FIG. 5 further shows an internal combustion engine 500 with a reciprocating piston system 300 as shown in FIG. 1.

The invention is not restricted to the preferred example of embodiment set out above. Rather, a number of variants are conceivable, which make use of the described solution even in fundamentally different types of embodiment. All features and/or advantages in accordance with the claims, the description or the drawings, including design details or spatial arrangements and method steps, can be essential to the invention in themselves or in various combinations.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A cylinder for a reciprocating piston system comprising:
a cylinder running surface that is finished by machining via a tool with one or several geometrically defined cutting edges; and
a plurality of pores and/or cavities formed on the finished cylinder running surface,
wherein the cylinder running surface being formed from a grey cast iron material with a proportion of a surface area that is taken up by the pores of 2 to 10% or formed from a thermally sprayed iron layer or a thermally sprayed ceramic layer with a proportion of the surface area that is taken up by pores of 5 to 25%.

2. The cylinder according to claim 1, wherein the finished cylinder running surface formed from a grey cast iron material has a proportion of the volume that is taken up by pores of 4 to 25 ml/m².

3. The cylinder according to claim 1, wherein the finished cylinder running surface formed from a thermally sprayed iron layer or from a thermally sprayed ceramic layer has a proportion of the volume that is taken up by pores of 20 to 60 ml/m².

4. The cylinder according to claim 1, wherein the finished cylinder running surface has a roughness with a core roughness depth R_{K}<1, 0 μm and a reduced peak height Rₚₖ<0.5 μm and a reduced groove depth Rᵥₖ of 0.5 to 8 μm.

5. The cylinder according to claim 1, wherein the cylinder running surface formed from grey cast iron material is finished such that hard material particles contained in the grey cast iron material are torn out.

6. The cylinder according to claim 1, wherein the cylinder running surface formed from a thermally sprayed iron layer or a thermally sprayed ceramic layer is finished such that at least a portion of the pores and/or cavities formed in the cylinder running surface are exposed.

7. A method for finishing a cylinder for a reciprocating piston system, the method comprising:
finishing a cylinder running surface of the cylinder via a tool with a geometrically defined cutting edge such that the cylinder running surface after the finishing has a plurality of pores and/or cavities; and
forming the finished cylinder running surface from a grey cast iron material with a proportion of the surface area that is taken up by pores of 2 to 10% or from a thermally sprayed iron layer or a thermally sprayed ceramic layer with a proportion of the surface area that is taken up by pores of 5 to 25%.

8. The method according to claim 7, wherein the cylinder running surface formed from grey cast iron material is finished such that hard material particles contained in the grey cast iron material are torn out.

9. The method according to claim 7, wherein the cylinder running surface formed from a thermally sprayed iron layer or a thermally sprayed ceramic layer is finished such that a portion of the pores and/or cavities formed in the cylinder running surface are exposed.

10. The method according to claim 7, wherein the finishing is carried out without a cooling lubricant.

11. The method according to claim 7, wherein the cutting edge has a cutting edge radius <10 μm.

12. The method according to claim 7, wherein the tool is used together with an adaptronic, radially deflectable spindle for a form processing for distortion compensation.

13. A reciprocating piston system comprising a cylinder and a piston mounted movably in the cylinder, wherein the cylinder is configured according to claim 1.

14. The reciprocating piston system according to claim 13, wherein the reciprocating piston system is a piston system in an internal combustion engine, a supercharger, a compressor, or a pump.
